(19) United States
(12) Patent Application Publication
(10) Pub. No.: US 2012/0196040 A1
(43) Pub. Date: Aug. 2, 2012

(54) REFRACTORY MATERIAL IMPREGNATED WITH PHASE CHANGE MATERIAL, METHOD FOR MAKING THE SAME, AND TEMPERATURE CONTROLLED CHAMBER FORMED BY THE SAME

(76) Inventors: Richard Wilk, JR., Lisbon, OH (US); Jonathan Abi, Stow, OH (US)

(21) Appl. No.: 13/364,310

(22) Filed: Feb. 1, 2012

Related U.S. Application Data
(60) Provisional application No. 61/438,363, filed on Feb. 1, 2011.

(51) Int. Cl. B05D 3/00

(52) U.S. Cl. 427/294; 427/398.1

(57) ABSTRACT

The present invention is directed to methods for forming heat absorbing bodies (and the resulting heat absorbing bodies and enclosures formed thereby) that utilize capillary action to draw a fluidic composition comprising a molten phase change material (PCM) into the interstitial spaces of a porous body of a refractory material. In one embodiment, the fluidic composition saturates substantially all of the interstitial spaces of a porous body of a fibrous ceramic refractory material.

The present application claims the benefit of U.S. Provisional patent application Ser. No. 61/438,363, filed Feb. 1, 2011, the entirety of which is hereby incorporated by reference herein.

### FIELD OF THE INVENTION

The present invention relates generally to refractory materials, and specifically to boards of refractory materials that are impregnated with a phase change material to increase thermal absorption capacity, wherein such boards can be used to endothermically cool and/or thermally insulate a chamber.

### BACKGROUND OF THE INVENTION

Historically, non-reactive insulation material or water containing species have been used to slow down energy transfer into a protected cavity that has heat sensitive items by surrounding it in a cocoon of insulation. Typically, the goal is to design units to keep temperatures below 350° F. for paper and 125° F. for electronic media. This problem has been addressed in various ways by the prior art.

To protect items from damage in the event of a fire, it is common that fire-resistant computer storage apparatus provide sealed spaces surrounded by materials having low levels of thermal conductivity. Examples of such fire-resistant computer storage apparatus include U.S. Pat. Nos. 5,295,447 and 5,377,514 to Robbins et al. and U.S. Pat. Nos. 4,712,490 and 4,176,440 to Lichter.

One solution provides cabinetry for data storage media that features an integral air conditioning system to control the temperature of the area enclosing the data storage device. Another solution involves cabinetry containing apparatus to defeat the insulation during normal conditions.

U.S. Pat. No. 4,585,303 to Branc et al. and U.S. Pat. No. 4,495,780 to Koneko, et al. both disclose cabinetry that use environmental controls to maintain the temperature of active electronic device containers within the cabinet. Branc et al. discloses a disc drive isolation system including an environmental control involving a thermoelectric heat pump and fan. Temperature and humidity sensors located near the disk drive actuate the heat pump to regulate the thermal conditions inside the cabinet. Similarly, Koneko et al. discloses the use of a cooling system to cool electronic devices housed within a hermetically closed chamber.

Cabinetry featuring environmental control systems like those disclosed in Branc et al. and Koneko et al. are expensive to buy and costly to maintain. More importantly, these systems create new risks that a data storage device stored within the cabinetry will be damaged resulting in lost data. Because these cabinets require active thermal regulation to control temperatures in the area surrounding the storage device, a loss of that active thermal regulation will result in increased temperatures and damage to the storage media. It is only possible to avoid such a result when using these cabinets through exceptional maintenance and service practices, or by designing a system that automatically shuts down if the temperature exceeds a set limit. This latter alternative is unacceptable in real-time business systems.

U.S. Pat. No. 5,623,597 to Kikinis presents two alternative systems, an “active” system and a “passive” system, for protecting a data storage device. In the “active” system, a data storage device is mounted onto a heat sink structure within a fireproof enclosure. A heat transfer system involving a radiator is connected to the heat sink and circulates a coolant through the wall of the fireproof enclosure. A thermostat controller is mounted on the outside of the wall to disable the heat transfer system in the event of a fire.

In the “passive” system, a data storage device is similarly attached to a heat sink. In this system, however, thermal-insulating material has a gap that permits the heat sink to be urged into contact with the exterior metal surface of the cabinet by a set of springs. This allows for the discharge of the heat generated by the data storage device during normal operation. If the thermostat detects fire, it releases a pressurized liquid insulting material into the space between the metal surface and the heat sink. This separates the heat sink from the metal surface of the fire-resistant computer storage apparatus and provides a degree of insulation.

Both embodiments of the Kikinis system create a risk of failure in that the key thermal management component, the thermostat, may fail. In the event of a failure of the thermostat, heat from a fire will be conveyed directly to the data storage device. This will be likely to have catastrophic consequences for the data storage device.

In addition, the “passive” embodiment of this system involves the increased risk of failure associated with the use of a pressurized insulation injection system that must stay fully charged until it is necessary to activate. Alternative versions of this “passive” embodiment include the use of electrical, mechanical, and electromechanical means to separate the heat sink from the metal exterior of the fire-resistant computer storage apparatus. All of these systems have the potential to fail to operate, particularly if they are unused for a period of months or years. To lower these risks, the thermostat, heat transfer system, insulation injection system, and separation means must also be maintained and tested periodically. Thus, what is needed is a cabinet to protect a data storage device that is fully passive and requires no maintenance, yet provides adequate thermal protection.

U.S. Pat. No. 6,158,833 to Engler describes an inner layer of thermal insulation composed of a phase change material. Two layers of low thermal conductivity material surround the layer of phase change material, slowing the rate of energy transferred into the protected volume of the unit. There are limitations to the method, since the phase change material, when melted, may pull towards the bottom of the unit, allowing heat transfer through the upper portions of the protecting unit.

U.S. Pat. No. 6,736,473 to Cleveland describes an inner surface with a composition comprising isolative and intumescent materials, preferably mineral wool insulation and hydrated sodium silicate fiberboard. An air space is provided between the tire resistant materials and the wall. The hydrated Fiberboard will swell and thereby seal the container while undergoing progressive dehydration and intumescence. However, this method allows the interior of the protected cavern to become too hot for electronic media, serving to protect documents.

U.S. Pat. No. 6,899,161 to Ren describes a composition comprising a polyoxymethylene (POM) polymer and also a binder. The polyoxmethylene polymer exists in a solid state at normal temperatures that undergoes an endothermic decomposition when exposed to the high temperature environment, but remains a solid state during endothermic decomposition. The composition absorbs heat from the high temperature environment during the endothermic decomposition of the polymethylene polymer and dissipates heat away from the heat sensitive device. The POM compositions employed include a polyoxymethylene polymer having the general formula:

H-(—O—CH2-)n-OH

Typical commercially available POM materials like DELRIN from Dupont are available.

When the POM decomposes it releases formaldehyde, which will absorb some energy as it is physically transported from the unit. However, this method has the following limitations: The degradation product of POM, formaldehyde, is a flammable gas. The formaldehyde may help fuel a conflagration localized around the fire protection unit, thereby causing premature failure. Also, people close to the unit while it is degrading, firemen suppressing the fire, or homeowners or employees escaping a burning building, for example, may be exposed to hazardous formaldehyde vapor.

U.S. Pat. No. 7,399,719 to Hanan describes a container including a first fiber based material loaded with a second material which endothermically decomposes above a pre-determined temperature T in degrees Celcius which is greater than 125 and less than 500. An endothermic phase change material (PCM) is enclosed in a PVC liner, so as to act as a thermal “sink.” This material is a mineral with crystalline water content. Examples of the material include Mg(OH)₂, which decomposes into MgO and H₂O. The decomposition provides an endothermic absorption of energy with the release of water. Another material, such as Ca(OH)2, does the same, although with less efficiency with respect to mass. The method of manufacturing involves the introduction of Mg(OH)₂ into a slurry of porous RCF insulation board before the board is formed. One limitation of this technique is that one reagent degrades with time. Also, the endothermic material does not react, but only degrades. As a result, there is no overall cooling effect, only energy absorption.

Additional examples of previous attempts at providing protection to heat sensitive items can be found in United States patents not mentioned herein. However, none of the previous attempts, whether mentioned herein or omitted from discussion, have provided a solution that is adequate to all situations. Thus, a need exists for an improved apparatus, method and/or system for protecting heat sensitive items, such as electronic storage media, against conflagrations or other heat-related damage. A need also exists for an improved manufacturing technique for forming boards that can be used in such apparatus and systems.

### BRIEF SUMMARY OF THE INVENTION

The present invention is directed to methods for forming heat absorbing bodies that utilize capillary action to draw molten phase change material into interstitial spaces of a body of a porous refractory material. In certain embodiments, the porous refractory material can comprise a fibrillary matrix of one or more refractory materials, such as for example alumina silica fibres. In certain other embodiments, a first reagent can be entrained within the solidified PCM and/or a second reagent can be positioned adjacent the body of the porous refractory material that is impregnated with the PCM.

In one embodiment, the invention can be a method of forming a heat absorbing body comprising: a) forming a porous body of a refractory material, the porous body comprising interstitial spaces; b) forming a bath of a molten phase change material (PCM); and c) positioning the porous body of the refractory material in contact with the molten PCM in the bath, the molten PCM being drawn into the interstitial spaces of the porous body of the refractory material via capillary action to form a PCM impregnated refractory body; and d) cooling the PCM impregnated refractory body so that the molten PCM of the PCM impregnated refractory body solidifies.

In another embodiment, the invention can be a heat absorbing body comprising: a porous body of a refractory material having interstitial spaces; and a solidified phase change material (PCM) in the interstitial spaces of the porous refractory material.

In still another embodiment, the invention can be a thermally protected enclosure comprising: a housing forming an internal chamber; at least one wall of the housing comprising a heat absorbing section; and the heat absorbing section comprising a first layer comprising a porous body formed of a refractory material having interstitial spaces, and a solidified phase change material (PCM) in the interstitial spaces of the porous body.

In yet another embodiment, the invention can be a method of forming a heat absorbing body comprising: a) forming a body comprising a fibrillary matrix of one or more refractory materials, wherein the fibrillary matrix has interstitial spaces; b) contacting said body with a composition comprising a molten phase change material (PCM) for a time sufficient to saturate substantially all of said interstitial spaces with said composition; and d) cooling said substantially saturated body for a time sufficient to solidify the molten PCM.

In a further embodiment, the invention can be a heat absorbing body comprising: a fibrillary matrix of one or more refractory materials, said matrix having interstitial spaces; and a solidified phase change material (PCM) contained within the interstitial spaces of said matrix.

In an even further embodiment, the invention can be a thermally protected enclosure comprising; a housing forming an internal chamber; at least one wall of the housing comprising a heat absorbing section; and the heat absorbing section comprising a first layer comprising a body comprising a fibrillary matrix comprising one or more refractory materials, the matrix having interstitial spaces, and a solidified phase change material (PCM) contained within said interstitial spaces.

In another embodiment, the invention can be a method of forming a heat absorbing section for an enclosure comprising: a) forming a porous body of a refractory material, the porous body comprising interstitial spaces; b) contacting the porous body of the refractory material with a fluidic composition comprising a molten phase change material (PCM), the fluidic composition being drawn into the interstitial spaces of the porous body of the refractory material via capillary action to form a PCM impregnated refractory body; c) cooling the PCM impregnated refractory body so that the molten PCM of the fluidic composition solidifies, thereby forming a first layer of the heat absorbing section; and d) positioning a second reagent adjacent the first layer.

In a further embodiment, the invention can be a method of forming a heat absorbing body comprising: positioning a porous body of a refractory material in contact with a bath of a fluidic composition comprising a molten phase change material (PCM), the fluidic composition being drawn into interstitial spaces of the porous body of the refractory material via capillary action to form a PCM impregnated refractory body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic of a board of a porous refractory material according that is used in accordance with embodiments of the present invention.

FIG. 2A a schematic illustrating the formation of an aqueous slurry used to form the board of the porous refractory material of FIG. 1, according one embodiment of the present invention;

FIG. 2B is a schematic illustrating the aqueous slurry formed in the process step of FIG. 2A, wherein a vacuum is applied to the aqueous slurry to dehydrate the aqueous slurry, according to an embodiment of the present invention;

FIG. 2C is a schematic illustrating the board of the porous refractory material resulting from the process step of FIG. 2B, according to an embodiment of the present invention;

FIG. 3A is a schematic illustrating a bath of granular phase change material (PCM) in solid form wherein heat is being applied thereto, according to an embodiment of the present invention;

FIG. 3B is a schematic illustrating a bath of a fluidic composition comprising molten PCM resulting from the process step of FIG. 3A;

FIG. 4A is a schematic illustrating the board of the porous refectory material of FIG. 2C positioned in initial contact with the bath of fluidic composition of FIG. 3B, according to an embodiment of the present invention;

FIG. 4B is a schematic illustrating absorption of the fluidic composition from the bath of FIG. 4A into the interstitial spaces of the porous refectory material of the board due to capillary action after the process step of FIG. 4A, wherein a first period of time has lapsed;

FIG. 4C is a schematic illustrating the absorption of the fluidic composition into the interstitial spaces of the porous refectory material of the board due to capillary action after the process step of FIG. 4B, wherein a second period of time has lapsed such that substantially all of the interstitial spaces of the board are saturated with the fluidic composition, thereby forming a PCM impregnated refractory board, according to an embodiment of the present invention;

FIG. 4D is a schematic of the PCM impregnated refractory board of FIG. 4C, wherein the molten PCM of the fluidic composition has cooled to solidification, according to an embodiment of the present invention;

FIG. 5A is a perspective view of a thermally protected enclosure in which the PCM impregnated refractory board of FIG. 4D has been incorporated therein, according to an embodiment of the present invention;

FIG. 5B is a cross-sectional view of the thermally protected enclosure of FIG. 5A, according to an embodiment of the present invention;

FIG. 6A is a schematic illustrating a bath of granular phase change material (PCM) in solid form wherein heat is being applied thereto, according to an alternate embodiment of the present invention;

FIG. 6B is a schematic illustrating the addition of a first reagent to the bath of molten PCM resulting from the process step of FIG. 6A to form a fluidic composition comprising the molten PCM and the first reagent;

FIG. 6C is a schematic of a bath of a fluidic composition comprising the molten PCM and the first reagent resulting from the process step of FIG. 6B;

FIG. 7A is a schematic illustrating the board of the porous refectory material of FIG. 1 positioned in initial contact with the bath of the fluidic composition of FIG. 6C, according to an alternate embodiment of the present invention;

FIG. 7B is a schematic illustrating absorption of the fluidic composition from the bath of FIG. 7A into the interstitial spaces of the porous refectory material of the board due to capillary action after the process step of FIG. 7A, wherein a first period of time has lapsed;

FIG. 7C is a schematic illustrating the absorption of the fluidic composition into the interstitial spaces of the porous refectory material of the board due to capillary action after the process step of FIG. 7B, wherein a second period of time has lapsed such that substantially all of the interstitial spaces of the board are saturated with the fluidic composition, thereby forming a PCM impregnated refractory board, according to an alternate embodiment of the present invention;

FIG. 7D is a schematic of the PCM impregnated refractory board of FIG. 7C, wherein the molten PCM of the fluidic composition has cooled to solidification entraining the first reagent therein, according to an embodiment of the present invention;

FIG. 8A is a perspective view of a thermally protected enclosure in which the PCM impregnated refractory board of FIG. 7D has been incorporated therein as a first layer adjacent a second layer comprising a second reagent, according to an alternate embodiment of the present invention; and

FIG. 8B is a cross-sectional view of the thermally protected enclosure of FIG. 8A, according to an alternate embodiment of the present invention.

### DETAILED DESCRIPTION OF THE INVENTION

The following description of the preferred embodiment(s) is merely exemplary in nature and is in no way intended to limit the invention, its application, or uses.

The present invention is broadly directed to methods for forming heat absorbing bodies (and the resulting heat absorbing bodies and enclosures formed thereby) that utilize capillary action to draw a fluidic composition comprising a molten phase change material (PCM) into the interstitial spaces of a porous body of a refractory material. As will be described in greater detail below, in one embodiment, the fluidic composition consists essentially of the molten PCM. In another embodiment, the fluidic composition comprises only the molten PCM (with, of course, the existence of impurities). In still another embodiment, the fluidic composition can comprise a first reagent in addition to the molten PCM.

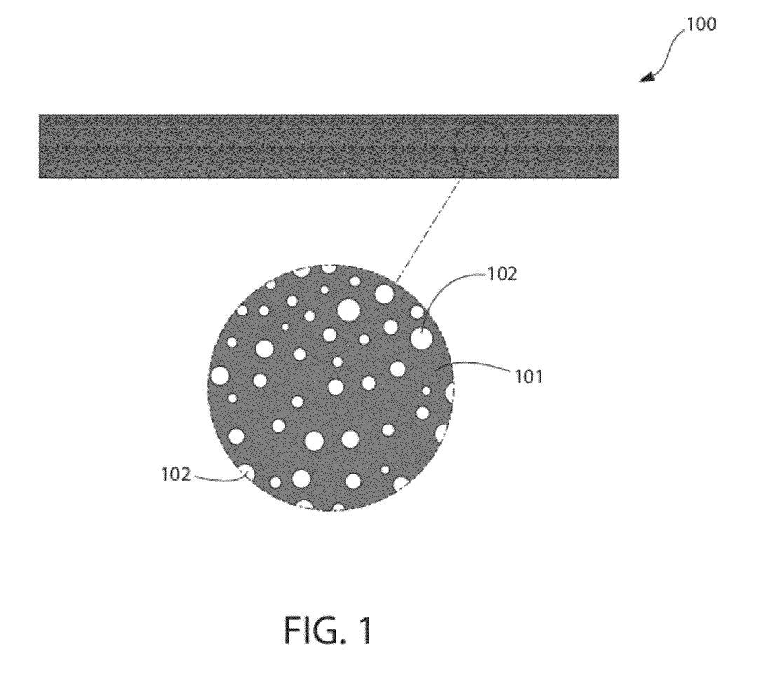

Referring to FIG. 1, an exemplary embodiment of a porous board 100 of a refractory material 101 that can be used in practicing the present invention is schematically illustrated. As used herein, the term “board” is not limited to any specific dimensions or relative dimensions, unless specifically recited in the claims. In one embodiment, the porous board 100 comprises a refractory material 101 (illustrated in grayscale) and a plurality of interstitial spaces 102 dispersed through the entire volume of the porous board 100. While the interstitial spaces 102 are exemplified as being circular in nature in the drawings for convenience of illustration, the interstitial spaces 102 can take on a wide variety of sizes and shapes in actual reductions of the invention, including regular and irregular shapes. Moreover, in certain embodiments, the interstitial spaces 102 can be open cell spaces, closed cell spaces, or combinations thereof. Furthermore, the term “porous,” as used herein in relation to the “board,” is not to be construed as being limiting of the size, shape, and/or interconnectivity (or lack thereof) between the interstitial spaces 102.

In certain embodiments of the invention, the average number of interstitial spaces 102 per cubic inch is substantially similar throughout the porous board 100. In another embodiment, the average volume of the sum of the interstitial spaces 102 located within any selected cubic inch of the porous board is substantially the same throughout the volume of the porous board 100. Of course, the invention is not so limited in all embodiments. Furthermore, as will be described in greater detail below, the interstitial spaces 102 are sized so as to be capable of drawing a desired molten PCM into the interstitial spaces solely by capillary action in certain embodiments, and are also capable of maintaining the molten PCM within the interstitial spaces due to said capillary forces (even when a solidified form of the PCM within the interstitial spaces 102 subsequently melts, for example during use within a thermally protected enclosure). The exact size and number of the interstitial spaces 102 distributed within the porous board 100 will be determined on a case-by-case basis taking into considerations such as, without limitation, the viscosity of the molten PCM with which it is to be used and the desired amount of PCM to be impregnated into the porous board 100.

In one embodiment, the porous board 100 is formed to have a density in a range of about 10 to 25 pounds per feet cubed, and in a more preferred embodiment between in a range of about 15 to 20 pounds per feet cubed. In one specific embodiment, the porous board 100 has a density in a range of about 19 to 21 pounds per feet cubed. In another specific embodiment, the porous board 100 has a density in a range of about 14 to 16 pounds per feet cubed. Of course, in other embodiments of the invention, the porous board 100 may have a density that is below or above the recited ranges.

In one embodiment, the porous board 100 can be a substantially rigid body. In other embodiments, the porous board 100 can have a degree of flexibility. In certain alternate embodiments, a porous body of refractory material 100, in the form of a blanket, can be used instead of the porous board 100, such as for example a felt blanket. Still alternatively, a porous body of refractory material 100, in the form of a fabric, can be used instead of the porous board 100. When blankets and/or fabrics used as the porous body, the porous body may be a fibrous weave or a fibrous matrix.

In certain embodiments of the invention, the refractory material 101 used to create the porous body can take the form of, without limitation, boards (Duraboard or Gemcolite, for example), blanket, paper, felt, or bulk fiber. There are also biosoluble RCF materials available (Isofrax and Soluwool, for example) that are a more consumer friendly option.

The porous board 100, in certain embodiments, may take the form of a porous fibrous body. For example, in one embodiment, the refractory material 101 of the porous board formed by refractory ceramic fibers. The refractory material 101, in the exemplified embodiment, is a fibrous body comprising a fibrillary matrix that forms the interstitial spaces 102. The fibrillary matrix can comprise one or more refractory materials, such as refractory fibres. The refractory material 101, in certain embodiments, may also comprises a binder and/or on or more additives. One suitable refractory material 101 is disclosed in U.S. Pat. No. 7,825,052, entitled Refractory Material For Reduced SiO2 Content, issued Nov. 2, 2010, the entirety of which is incorporated by reference herein. The refractory fibres, in preferred embodiments, are alumina silica fibres and the binder is a combination of colloidal silica and an organic or inorganic binder.

In one embodiment, the refractory material 101 is formed from a mixture of alumina silica fibres, colloidal silica and an inorganic binder. In one such embodiment, the refractory material 101 (and thus the porous hoard 10) comprises by weight about 60% to 80% silica, 15% to 35% alumina, and 2% to 10% of an inorganic binder. The preferred inorganic binder is a clay binder that is included at 5% by weight. Other inorganic binders include synthetic polymeric binders, such as phenol formaldehyde and urea-formaldehyde.

In another embodiment, the refractory material 101 is formed from a mixture of alumina silica fibres, colloidal silica and an organic binder. In one such embodiment, the refractory material 101 (and thus the porous board 100) comprises by weight about 30% to 40% silica, 50% to 70% alumina, and 2% to 10% of an organic binder. Suitable organic binders include naturally occurring polymeric materials such as starch, latex, tree gum and the like.

Other suitable binders may include a colloidal suspension of oxides, metals and non-metals such as alumina, zirconia, titania and so forth. Binders are typically available as water-based or oil-based liquids. However, the amount of the binders in the refractory material 101 is expressed as a solid weight

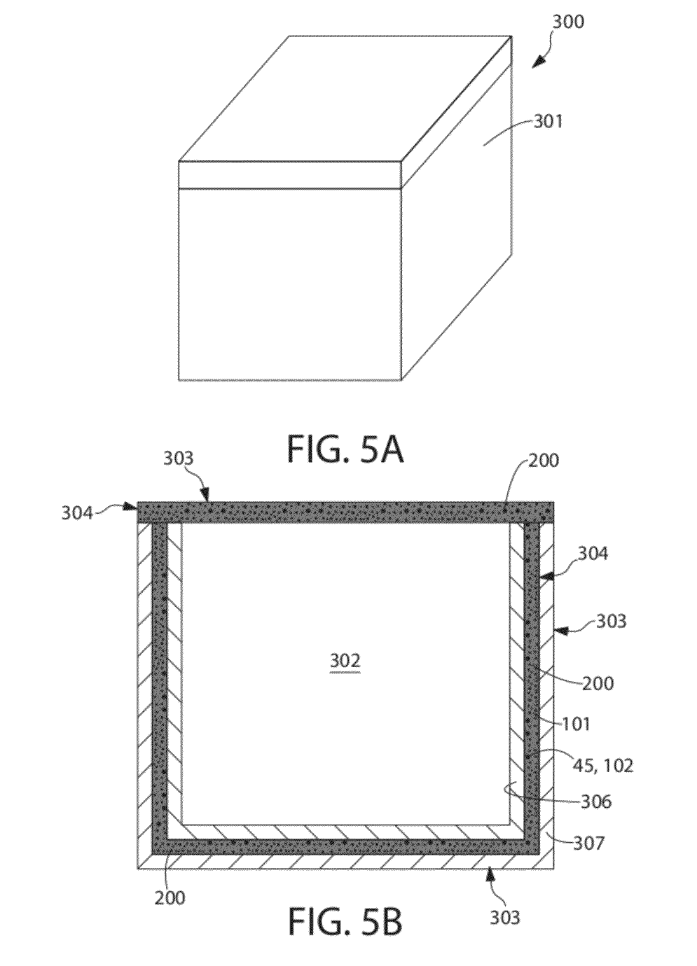

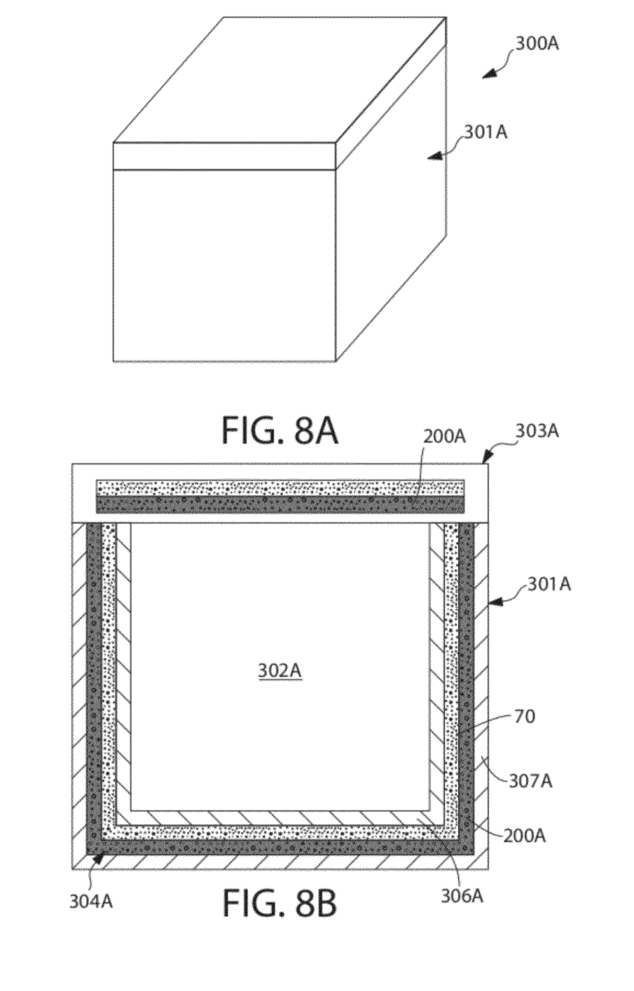

A benefit of using one of the refractory materials described above is that that the resulting porous body will have a relatively low linear firing shrinkage temperature which facilitates sizing an enclosure (FIGS. 5A-5B and FIGS. 8A-8B) just large enough to enclose the chamber being encapsulated and helps prevent subsequent problems that shrinkage might cause. The refractory material 101 will have an extremely low-k while at the same time having very high capacity to absorb heat and resist deformation, even when heated to extreme temperatures.

The refractory material 101 results in the porous board 100 (or porous body) having a low thermal conductivity material with an effective heat capacity greater than 70 JkgK and density greater than 200 kg/m.sup.3. Using the porous board 100 of the refractory material 101 to form the enclosure, and encapsulate

Another benefit is that once a container is formed from alumina-silica based ceramic fiber, the container is rigid, and is very resistant to deformation. As such, it protects an encapsulated system from being crushed or otherwise damaged should a wall, ceiling, or other structure collapse on it. Similarly, a comparatively high modulus of rupture also helps protect the encapsulated system. Yet another benefit is that the material is relatively impermeable. This allows it to provide some protection against damage from water, gasses, or other pollutants. Another benefit is the relative ease and cost efficiency with which such materials can be formed into complex shapes such as those desirable when encapsulating electronic and electromechanical units.

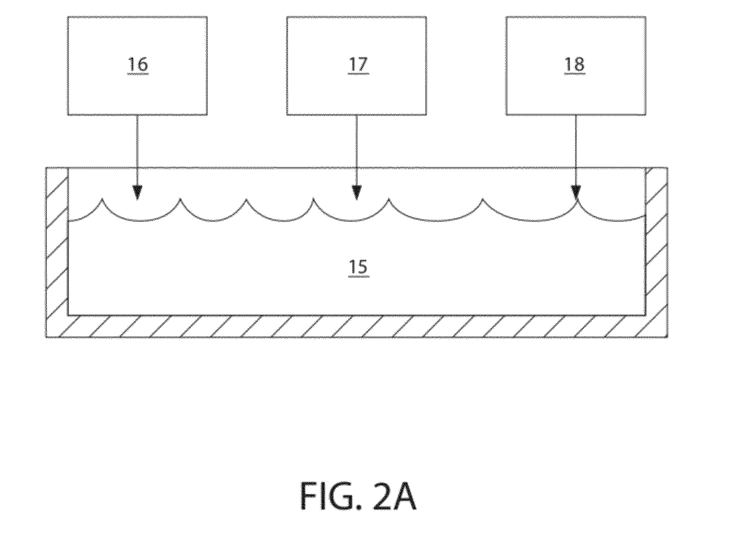

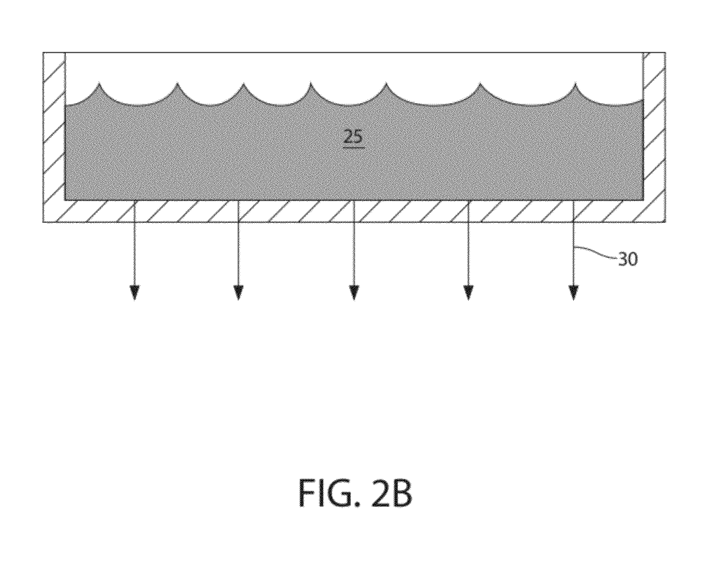

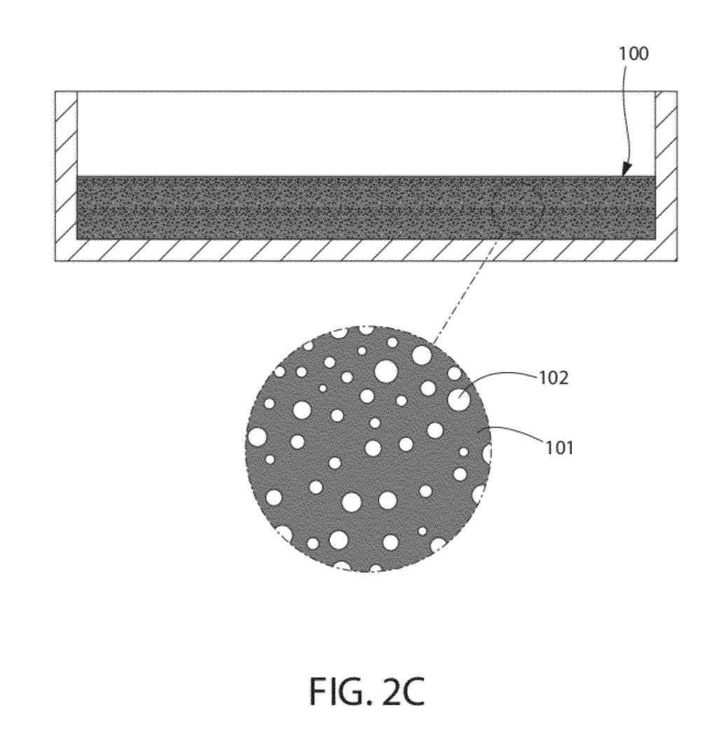

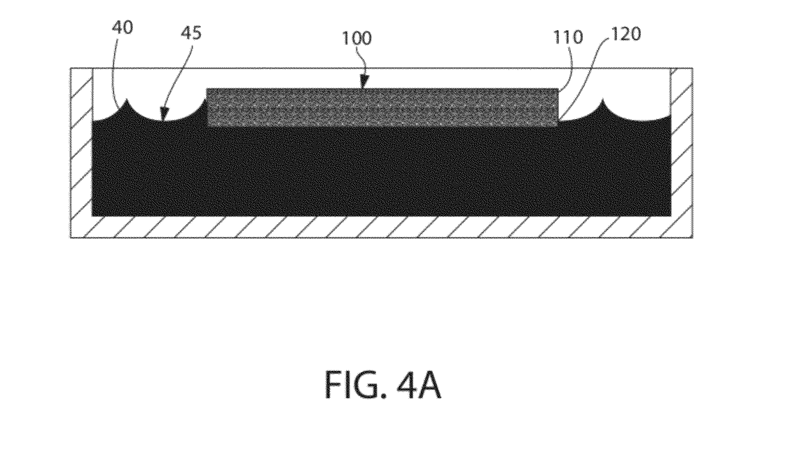

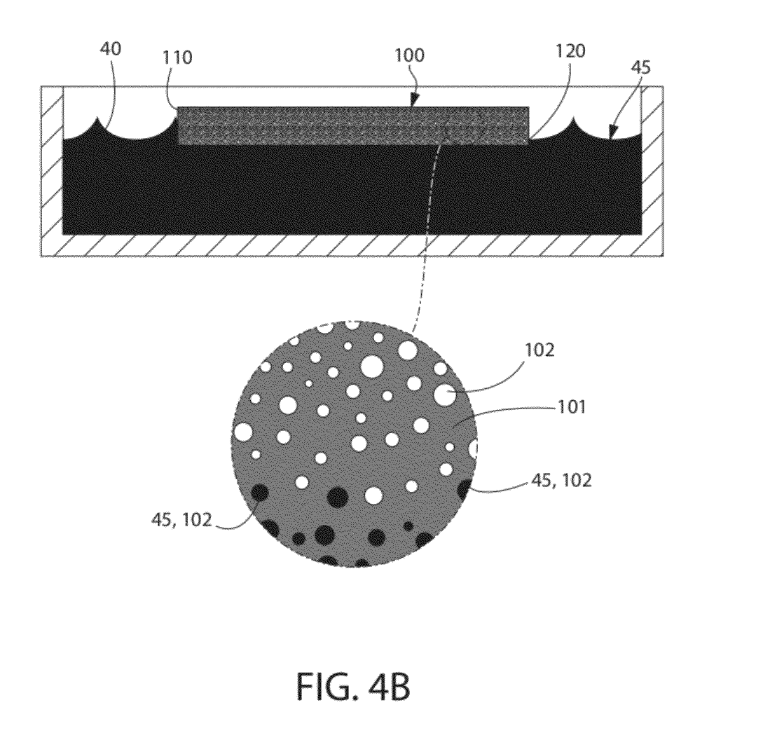

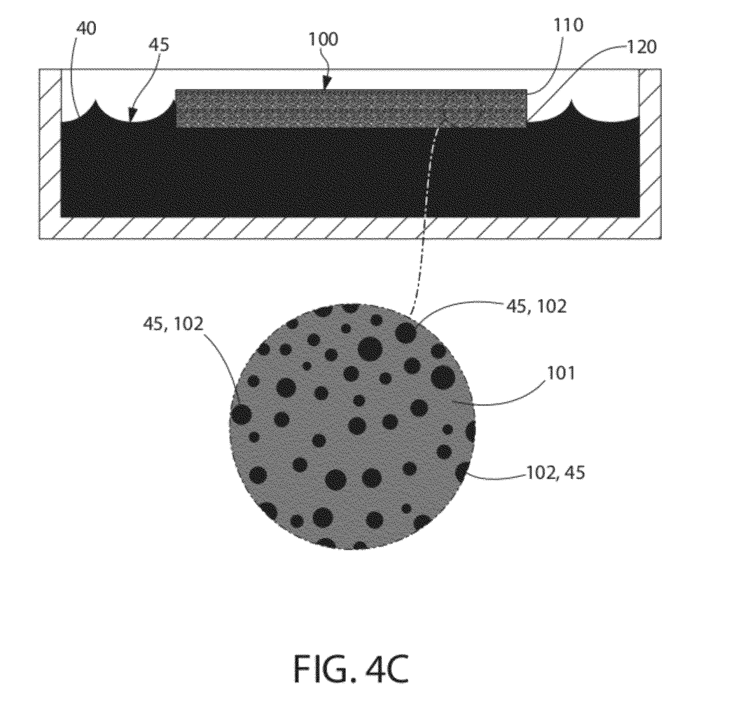

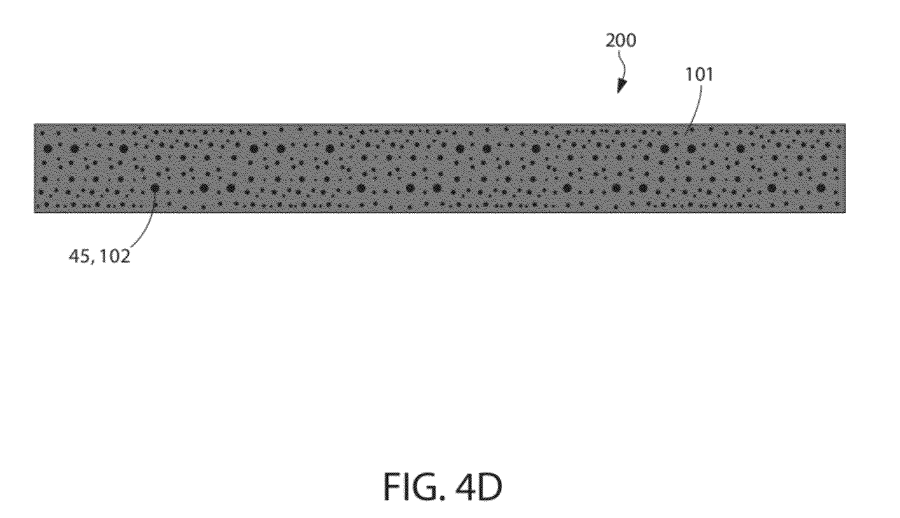

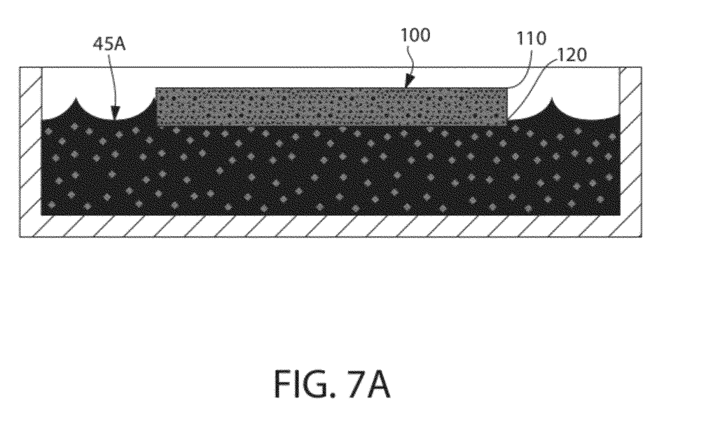

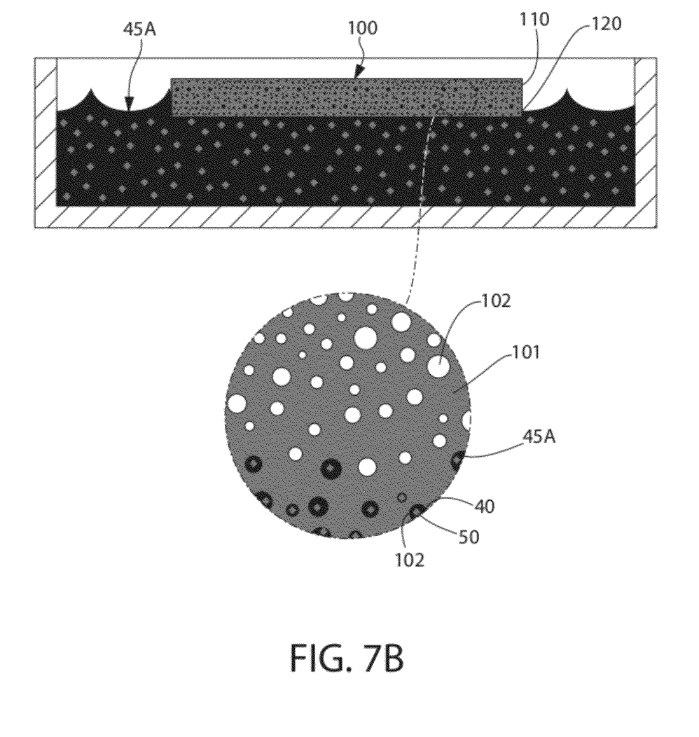

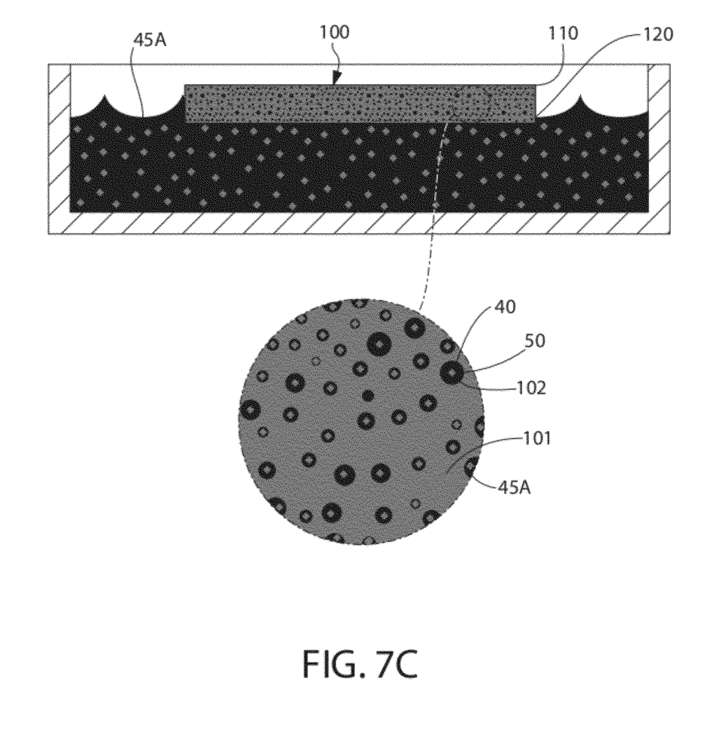

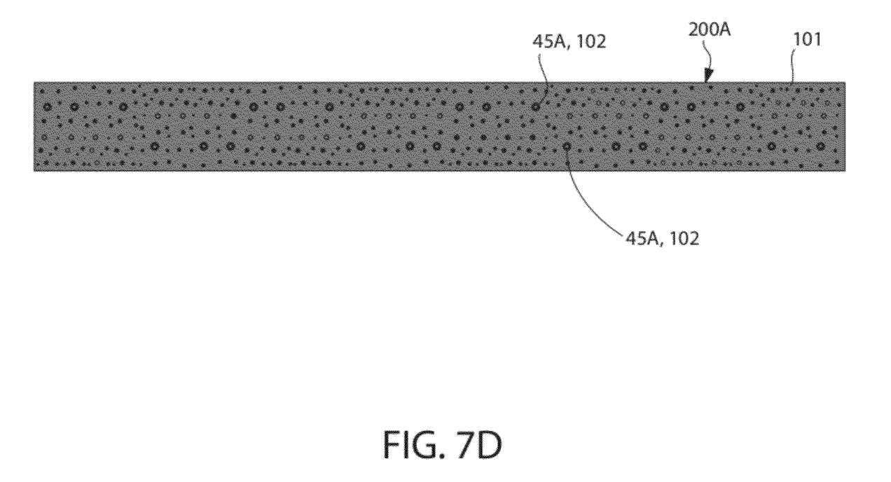

Referring now to FIGS. 2A-2C, the formation of the porous board 100 of FIG. 1 using a vacuum process according to one embodiment of the present invention will be described. As discussed below in relation to FIGS. 4A-4D and FIGS. 7A-7D, the porous board 100 can be used to absorb any of the permutations of the fluidic composition described herein. It is to be understood, however, that in other embodiments of the present invention, the porous board 100 can be formed according to other manufacturing methods known in the art for refractory boards or refractory blankets, including without limitation pressing, molding, weaving, milling, or combinations thereof.

Referring now to FIG. 2A, a bath of water 15 is initially drawn. Once the bath of water 15 is drawn, an amount of silica fibres 16, an amount of colloidal silica 17 and an amount of a clay binder 18 is added to the bath of water 15 to form a bath of an aqueous slurry 25 (FIG. 2B). In one specific embodiment, the bath of water 15 is in a range of about 750 to 1250 gallons, the amount of silica fibres 16 is in a range of about 100 to 150 pounds, the amount of colloidal silica 17 is in a range of about 15 to 25 pounds, and an amount of a clay binder 18 is in a range of about 3 to 5 pounds. Of course, the exact amounts of the materials being added to the bath of water 10 can vary depending on the desired resulting characteristics of the porous board 100 and/or the refractory material 101. Moreover, the identity of the materials may also vary depending on the desired make-up of the refractory material 101.

Referring now to FIG. 2B, once the amount of silica fibres 16, the amount of colloidal silica 17 and the amount of a clay binder 18 have been added to the bath of water 15 and mixed, an aqueous slurry 25 results. In one embodiment, the aqueous slurry 25 is about 1 to 3% by weight solids. Of course, other percentages are possible. Once the aqueous slurry 25 is formed, a vacuum 30 (illustrated as arrows) is applied to the aqueous slurry 25 through a die screen, thereby dehydrating the aqueous slurry. In one embodiment, the vacuum 30 is applied while the aqueous slurry 25 is maintained at approximately room temperature. In an alternate embodiment, the aqueous slurry 25 can be dehydrated in other manners, including without limitation heating.

Referring now to FIG. 2C, dehydration of the aqueous slurry 25 results in the formation of the porous board 100, which is described above in detail with respect to FIG. 1.

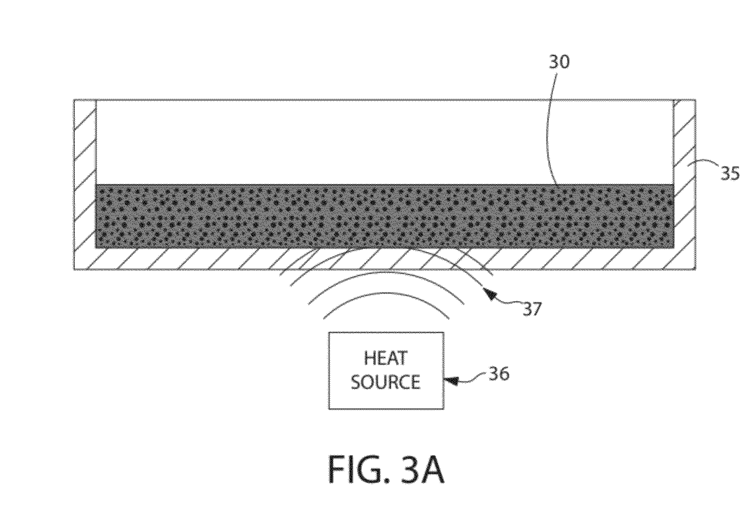

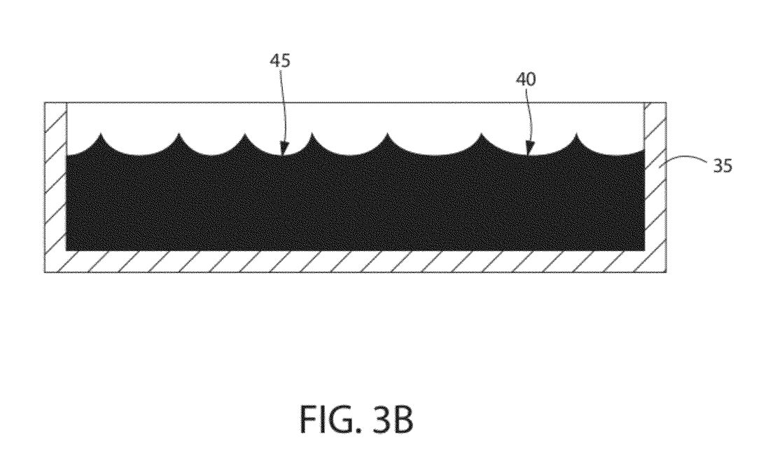

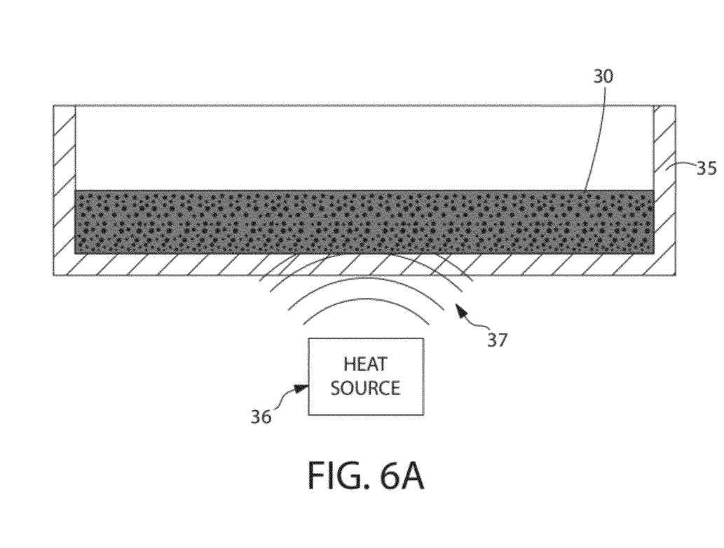

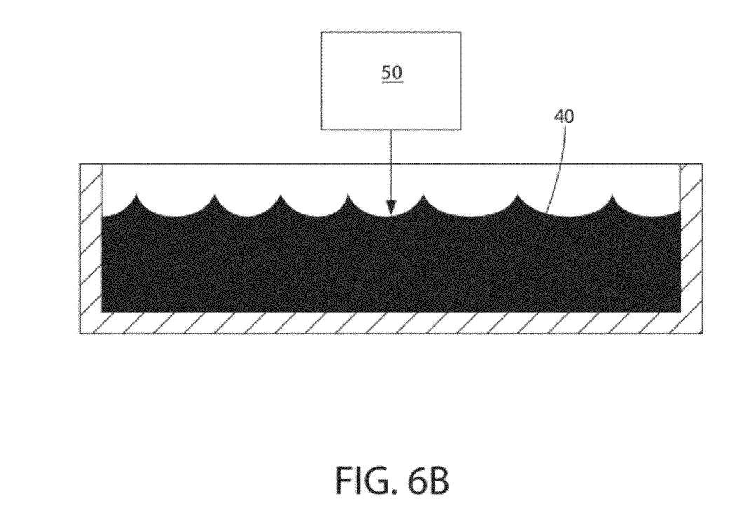

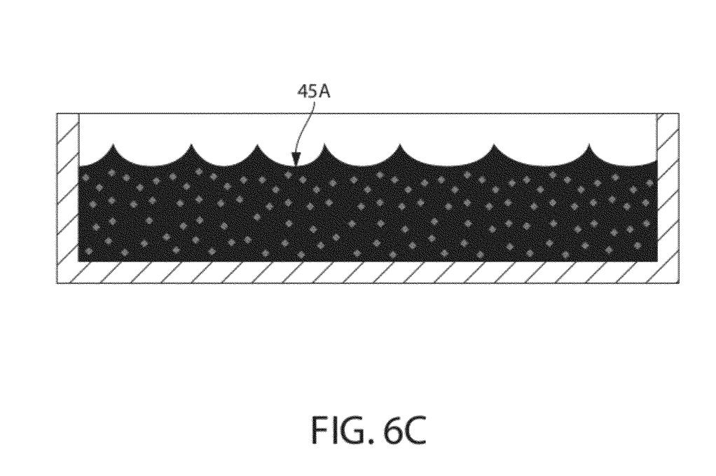

Referring now to FIGS. 3A-3B, the formation of a fluidic composition comprising a molten PCM will be described. In the embodiment of FIGS. 3A-3B, the fluidic composition consists essentially of the molten PCM. However, in other embodiments, the fluidic composition can comprise other materials and/or compounds, one such embodiment of which will be described below in reference to FIGS. 6A-6C.

Referring to FIG. 3A, a desired amount of a solid form of a PCM 30 is put into an open container or tray 35. In one embodiment, the solid form of the PCM 30 may be in granular form. In one embodiment, the PCM 30 is selected from a group consisting of a hydrated salt, a long-chain organic, a wax, and a combination of two or more thereof. In another embodiment, the PCM 30 is selected from a group consisting of a hydrated salt, a quaternary ammonium/water clathrate; and a combination of two or more thereof. In still another embodiment, the PCM 30 is selected from a group consisting of a crystalline alkyl hydrocarbon, a polyethylene glycol, pentaethritol, pentaglycerine, neo pentylglycol, acetamide, tetrahydrofuran, butyl stearate, butyl palmitate, lauric acid, capric acid, other fatty acids and esters, primary long chain alcohols, and a combination of two or more thereof. As used herein the term long-chain means compounds having 10 or more carbon units, and more preferably 12 or more carbon units. Suitable hydrated salts include, without limitation, sodium acetate tri-hydrate, calcium chloride hexahydrate, and sodium sulfate decahydrate.

In one embodiment, the PCM 30 is a solid at room temperature or below, which for purposes of the invention is in a range of 18° C. to 25° C. In other embodiments, the PCM 30 of the present invention has a melting temperature in a range of 30° C. to 45° C. The exact PCM 30 selected for the invention will be determined on a case-by-case basis taking into consideration the desired temperature at which the chamber of the enclosure is to be maintained.

Once the solid form PCM 30 is in the open container, sufficient energy is applied to the solid form PCM 30 to melt the solid form PCM 30, thereby forming a molten PCM 40 (FIG. 313), which in this example constitutes the fluidic composition. In the exemplified embodiment, a heat source 36 is provided that generates heat energy 37 that is transmitted into the solid form PCM 30, thereby melting the solid form PCM 30 (i.e., heating the solid form PCM to a temperature above its melting point). The heat source 36 can be a burner, an infra-red (IR) source, an electrical resistor, or any other device used to generate heat energy. Of course, in alternate embodiments, energies other than heat energy can be applied to melt the solid form PCM 30, such a radio frequency (RF) energy, sonic energy, megasonic energy, or combinations thereof. Melting the solid form PCM 30 is performed, in one embodiment, at ambient (i.e., standard atmospheric) pressure. However, in other embodiments, melting of the solid form PCM 30 can be performed in atmospheres having sub-atmospheric pressure or pressures greater than atmospheric pressure.

In one embodiment, it is preferred that the PCM 30 be a hydrated salt. In one such embodiment, the solid form of the hydrated salt is heated to a molten temperature that is between a first temperature at which the solid form of the hydrated salt melts and a second temperature at which the water within the hydrated salt evaporates. Conceptually, a molten temperature range is defined between the first temperature and the second temperature. In certain embodiments, the hydrated salt is heated to a temperature within an upper 50% of the molten range to form the bath of the fluidic compound (i.e., the molten hydrated salt).

Referring to FIG. 3B, melting of the solid form PCM 30 forms a bath of a fluidic composition 45 comprising the molten PCM 40 (which in the exemplified embodiment is the only material in the fluidic composition 45. Once the bath of the fluidic composition 45 comprising the molten PCM 40 is prepared, the porous board 100 of refractory material 101 is put into contact with the bath of the fluidic composition 45 comprising the molten PCM 40, as shown in FIG. 4A. Again, while the invention is described herein in relation to a porous board 100 of refractory material 101, it is to be understood that, in other embodiments, a porous body of refractory material 101 in the form of a blanket or a fabric could be used instead of or in addition to a board.

Referring now to FIGS. 4A-4D, the process by which the fluidic composition 45 comprising the molten PCM 40 impregnates the porous board 100 of the refractory material 101 will be described. While this process is exemplified in the form of putting the porous board 100 of the refractory material 101 in a bath of the fluidic composition 45 comprising the molten PCM 40, it is to be understood that, in certain alternate embodiments, the impregnation of the porous board 100 of the refractory material 101 with the fluidic composition 45 comprising the molten PCM 40 can be achieved using other techniques, such as spraying, pouring, vapor impregnation, or the like. In the preferred embodiment, the fluidic composition is, at least in part, in liquid form.

Referring now to FIG. 4A, the porous board 100 of refractory material 101 is put into the bath of the fluidic composition 45 comprising the molten PCM 40. The porous board 100 of the refractory material is positioned in the bath of the fluidic composition 45 so that a first portion 110 of the porous board 100 of the refractory material 101 is not in directed contact with (or not submerged in) the fluidic composition 145 while a second portion 120 of the porous board 100 of the refractory material 101 is in directed contact with (or submerged in) the bath of the fluidic composition 45. In the exemplified embodiment, the first portion 110 is an upper portion of the porous board 100 of the refractory material 101 while the second portion 120 is a lower portion of the porous board 100 of the refractory material 101. Of course, in alternate embodiments of the invention, the relative locations of the first and second portions 110, 120 on the porous board 100 of the refractory material 101 can be different. While the entirety of the porous board 100 of the refractory material 101 can be submerged in the bath of the fluidic composition 45 in certain embodiments of the present invention, such submersion in roto is considered less desirable as air pockets can trapped in interstitial spaces 102 in the interior volume of the porous board 100 of the refractory material 101. In the exemplified embodiment, the porous board 100 of the refractory material 101 is simply floated in the bath of the fluidic composition 45.

Referring now to FIG. 4B, shortly after (or immediately upon) the porous board 100 of the refractory material 101 being put into contact with the bath of the fluidic composition 45, the fluidic composition 45 begins to be drawn into (and potentially fill) the interstitial spaces 102 of the lower portion 120 of the porous board 100 of the refractory material 101 via capillary action.

Referring now to FIG. 4C, the porous board 100 of the refractory material 101 is maintained in contact with the bath of the fluidic composition 45 for a time sufficient for the fluidic composition 45 to be drawn into substantially all of said interstitial spaces 102 of the porous board 100 by capillary action (including the interstitial spaces 102 of the upper portion 120 of the porous board 100). As a result, substantially all of the interstitial spaces 102 of the porous board 100 become saturated with the fluidic composition 45. Conceptually, the porous board 100 itself can be considered saturated with the fluidic composition 45. As a result, a PCM impregnated refractory board 200 (FIG. 4D is formed). In one embodiment, the porous board 100 is maintained in contact with the bath of the fluidic composition 45 for a time between 1 to 5 minutes.

In one embodiment, the aforementioned processing of FIGS. 4A-4C takes place at atmospheric pressure. Thus, in such an embodiment, the fluidic composition 45 absorbs into substantially all of the interstitial spaces 102 of the porous board 100 solely by capillary action to saturate the porous board 100. In alternate embodiments, the environment may be pressured or sub-atmospheric.

Referring now to FIG. 4D, a PCM impregnated refractory board 200 that results from the process steps discussed above for FIGS. 4A-4C is illustrated according to an embodiment of the present invention. Once removed from the bath of the fluidic composition 45, the PCM impregnated refractory board 200 is cooled so that the molten PCM within the interstitial spaces 102 solidifies. This cooling can be a passive cooling in which the PCM impregnated refractory board 200 is simply placed in a room temperature environment and allowed to cool. Alternatively, the cooling can be an active cooling in which the PCM impregnated refractory board 200 is positioned within a chilled atmosphere and/or subject to a forced convective air flow.

Because the fluidic composition 45, in the exemplified embodiment, saturated substantially all of the interstitial spaces 102 of the porous board 100, the PCM impregnated refractory board 200 has a substantially constant density throughout its entirety. In one embodiment, the PCM impregnated refractory board comprises, by weight, about 60% to 80% solidified PCM, after cooling. In another embodiment, the porous board 100 of the refractory material 101 of FIG. 1 has a first density and the PCM impregnated refractory board 200 of FIG. 6 has a second density, wherein a ratio of the second density to the first density is in a range of 2.5 to 6.5. Of course, the weight percentages and density ratios can be outside of the range in certain other embodiments of the invention. Finally, as mentioned above, the interstitial spaces 102 are sized so that upon the solidified PCM being re-melted, the melted PCM will remain trapped in the interstitial spaces 102 due to capillary forces.

Referring now to FIGS. 5A and 5B concurrently, a thermally protected enclosure 300 is exemplified according to one embodiment of the invention in which the PCM impregnated refractory board 200 of FIG. 4D is implemented. The thermally protected enclosure 300 can be a cabinet or a container. The thermally protected enclosure 300 comprises a housing 301 that forms an internal chamber 302. One or more heat sensitive items can be positioned within the chamber. The housing 301 comprises a plurality of walls 303 that encapsulate the chamber 302. The PCM impregnated refractory board 200 is incorporated into the walls 303, thereby forming at least a portion of a heat absorbing section 304 of the walls. As used herein, the term “walls” includes a lid and a floor of the enclosure 300. In the exemplified embodiment, the heat absorbing section 304 (and thus the PCM impregnated refractory board 200) encapsulates the chamber 302. Of course, in other embodiments, the heat absorbing section 304 (and/or the PCM impregnated refractory board 200) may not fully encapsulate the chamber 302.

In the exemplified embodiment, the PCM impregnated refractory board 200 forms a first layer of the heat absorbing section 304. As discussed above, the PCM impregnated refractory board 200 comprises the refractory material 101 and the fluidic composition 45 (which includes solidified PCM) in the interstitial spaces 102.

In the event of exposure of the enclosure 300 to a high temperature environment, initial thermal protection of any heat sensitive items within the chamber 302 is provided by the low k of the PCM impregnated refractory board 200 itself. Moreover, as the PCM impregnated refractory board 200 heats up, the solidified PCM (which is the composition 45) absorbs heat energy and melts, thereby further insulating the chamber 302 form the heat. The low melting point of the solidified PCM in the PCM impregnated refractory board 200 ensures that the solidified PCM melts prior to the temperature in the chamber 302 reaching an undesirable predetermined threshold. However, the PCM, which is now in the molten state, does not flow by gravity to a bottom of the enclosure 300 but is instead retained in position within the interstitial spaces 102 by capillary action. As such, there is uniform thermal protection throughout the insulating surface, not “hot” and “cold” spots as a result of gravitational flow of molten material.

In embodiments where the solidified PCM is a hydrated salt (or other hydrated composition), the melting of the solidified hydrated salt uses a first amount of energy to break down the crystal structure of the salt, thereby releasing the water molecules. A second amount of thermal energy can then be absorbed by the vaporization of the water molecules. As a result, superior thermal insulation of the chamber 302 is achieved. Thus, the thermal capacity of PCM impregnated refractory board 200 is much greater than the porous board 100 of refractory material 101 (FIG. 1) by itself, despite being denser. Thus, the PCM impregnated refractory board 200 is a very dense mechanically bound material in which the PCM endothermically changes chemical composition at an adjustable temperature. Finally, as shown in FIG. 5B, the enclosure may further comprise an inner liner 306 and an outer liner 307 in between which the heat absorbing section 304 is sandwiched.

In an alternate embodiment of the enclosure 300, the heat absorbing section 304 comprises a second layer which comprises a second reagent (not illustrated). The second layer can be in the form of a powder, a solid or a liquid in various embodiments. In this embodiment, the solidified PCM in the PCM impregnated refractory board 200 is preferred to be a hydrated salt (or another hydrated compound). Thus, as described above, when the solidified PCM material melts, the water molecules in the hydrated salt are released. The water molecules may also be subsequently vaporized. The second reagent is selected so that, when exposed to the water molecules released from the hydrated salt (in either liquid or vapor form), the second reagent endothermically reacts with the water. For example, the second reagent can be sodium chloride. Of course, other compounds can be used for the second reagent.

Furthermore, in such embodiments, it may be desirable to isolate the second reagent from the solidified hydrated salt during normal use of the enclosure using a barrier. In one such embodiment, the barrier can be in the form of a meltable or dissolvable packet that encapsulates the second reagent, such as a packet made of PVA. The second layer of the

Referring now to FIGS. 6A-6C, the formation of a bath of a fluidic composition 45A comprising a molten PCM 40 and a first reagent 50 is illustrated according to a second embodiment of the present invention.

Referring solely now to FIG. 6A, a desired amount of a solid form of the PCM 30 is put into an open container or tray 35. In one embodiment, the solid form of the PCM 30 may be in granular form. The PCM 30 can be any of the PCMs discussed in relation to FIG. 3A. Once the solid form PCM 30 is in the open container, sufficient energy is applied to the solid form PCM 30 to melt the solid form PCM 30, thereby forming a molten PCM 40 (FIG. 6B). The melting of the solid form PCM 30 can be accomplished according to any of the techniques discussed above with respect to FIGS. 3A-3B.

Referring now to FIG. 6B, melting of the solid form PCM 30 forms a bath of molten PCM 40. An amount of a first reagent 50 is then added to the bath of the molten PCM 40, thereby forming the fluidic composition 45A comprising the molten PCM 40 and the first reagent 50. While the amount of the first reagent 50 is added to the bath of molten PCM 40 in the exemplified embodiment, the amount of the first reagent 50 can be added to the solid form PCM 30 prior to melting if desired. In one embodiment, the first reagent is a composition capable of reacting with a second reagent (discussed below in FIGS. 8A-8B) to generate carbon dioxide and water. In another embodiment, the first reagent can be a carboxylic acid. In certain embodiments, the carboxylic acid is selected from ascorbic acid and acetic acid. In one embodiment, the first reagent is in a range of 3% to 10%, by weight, of the fluidic composition 45A.

Once the bath of the fluidic composition 45A comprising the molten PCM 40 and the first reagent 50 is prepared, the porous board 100 of refractory material 101 (from FIG. 1) is put into contact with the bath of the fluidic composition 45A comprising the molten PCM 40 and the first reagent 50, as shown in FIG. 7A. Again, while the invention is described herein in relation to a porous board 100 of refractory material 101, it is to be understood that, in other embodiments, a porous body of refractory material 101 in the form of a blanket or a fabric could be used instead of or in addition to a board.

FIGS. 7A-7D illustrate the process by which the fluidic composition 45A comprising the molten PCM 40 and the first reagent 50 is absorbed into the interstitial spaces 102 of the porous board 100 to form a PCM impregnated refractory board 200A, in accordance with a second embodiment of the present invention. This process is identical to that which is discussed above for FIGS. 3A-3D for absorption of the fluidic composition 45 into the porous board 100 to form the PCM impregnated refractory board 200, with the exception that the fluidic composition 45A within the interstitial spaces 102 comprises both the molten PCM 40 and the first reagent 50. Moreover, upon the PCM impregnated refractory board 200A cooling so that the molten PCM 40 of the fluidic composition 45A within the PCM impregnated refractory board 200A solidifies, the first reagent 50 is entrained within the solidified PCM 40.

The PCM impregnated refractory board 200A comprising the composition of the first reagent 50 entrained within the solidified PCM 40 within its interstitial spaces 102 is particularly useful in applications in which a second reagent is provided. One such example is the enclosure 300A, described below with reference to FIGS. 8A-8B.

Referring now to FIGS. 8A-8B concurrently, a thermally protected enclosure 300A is exemplified according to one embodiment of the invention in which the PCM impregnated refractory board 200A of FIG. 7D is implemented. The thermally protected enclosure 300A can be a cabinet or a container. The thermally protected enclosure 300A comprises a housing 301A that forms an internal chamber 302A. One or more heat sensitive items can be positioned within the chamber 302A. The housing 301A comprises a plurality of walls 303A that encapsulate the chamber 302A. The PCM impregnated refractory board 200A is incorporated into the walls 303A along with a second reagent 70, thereby forming a heat absorbing section 304A of the walls 303A. As used herein, the term “walls” includes a lid and a floor of the enclosure 300A. In the exemplified embodiment, the heat absorbing section 304A, which comprises the PCM impregnated refractory board 200A and the second reagent 70, encapsulates the chamber 302A. Of course, in other embodiments, the heat absorbing section 304A may not fully encapsulate the chamber 302A.

In the exemplified embodiment, the PCM impregnated refractory board 200A forms a first layer of the heat absorbing section 304A while the second reagent 70 forms a second layer of the heat absorbing section 304A. The second reagent 70 is adjacent the PCM impregnated refractory board 200A. As discussed above, the PCM impregnated refractory board 200A comprises the refractory material 101 and the fluidic composition 45A, which comprises the solidified PCM 40 and the first reagent 50, in the interstitial spaces 102. The second reagent 70 can be manufactured as a powder or other solid pieces that are positioned adjacent the PCM impregnated refractory board 200A.

The second reagent 70 is selected so that when the second reagent 70 is exposed to the first reagent 50 (which is released when the solidified PCM 40 within the interstitial spaces 102 melts), an endothermic reaction between with the first reagent 50 and the second reagent 70 takes place. In certain embodiments, the second reagent 70 is a compound capable of endothermically reacting with the first reagent 50 to generate carbon dioxide and water. In one embodiment, the second reagent 70 is a carbonate species. The carbonate species can be selected from sodium bicarbonate and calcium carbonate.

In the event of exposure of the enclosure 300A to a high temperature environment, initial thermal protection of any heat sensitive items within the chamber 302A is provided by the low k of the PCM impregnated refractory board 200A. Itself. Moreover, as the PCM impregnated refractory board 200A heats up, the solidified PCM (which is the composition 45A) absorbs heat energy and melts, thereby further insulating the chamber 302A form the heat. The low melting point of the solidified PCM 40 in the PCM impregnated refractory board 200A ensures that the solidified PCM 40 melts prior to the temperature in the chamber 302A reaching an undesirable predetermined threshold. However, the PCM 40, which is now in the molten state, does not flow by gravity to a bottom of the enclosure 300A but is instead retained in position within the interstitial spaces 102 by capillary action. As such, there is uniform thermal protection throughout the insulating surface, not “hot” and “cold” spots as a result of gravitational flow of molten material.

Furthermore, melting of the PCM 40 releases the first reagent 50, which is no longer entrained in the PCM 40. The released first reagent 50 then comes into contact with the second reagent 70, thereby facilitating an endothermic reaction between the two that further protects the chamber 302A from being overly heated.

In one specific example of the enclosure 300A, the use of the reaction of a carbonate containing species, for example sodium bicarbonate or calcium carbonate, with a carboxylic acid containing reagent, for example, acetic acid or ascorbic acid, yields carbon dioxide and water. The overall reaction is endothermic, taking energy in the form of heat from its surrounding environment. The following reaction is provided merely as an example:

Sodium Bicarbonate+Ascorbic Acid+Energy→Sodium Ascorbate+Carbon Dioxide+Water NaHCO₃+C₆H₈O₆+E→NaC₆H₇O₆+CO₂+H2O

Other reactants can be used to generate an endothermic reaction in this method. For example, ammonium nitrate can react with the water in sodium acetate trihydrate to the same effect.

This reaction “absorbs” about 44 BTU per gram mol of reactant. The difficulty in using this in passive fire protection lies in getting the reaction to occur at the right time. Thus, mechanical separation of the first and second reagents (one or both dissolved in water) by a physical barrier, such as a membrane or packet, that melts at a specific temperature allows the first and second reagent to intermix at a desired time/temperature. In this embodiment, the chemical species are created integral into the fire-protective insulation. This saves space and weight, and makes for a more robust system, since there is no mechanical separation to engineer.

Carbon dioxide, or other gases, that form from the reaction between the first and second reagents can escape through the interstitial spaces 102, causing physical transport of energy away from the protected interior chamber 302A. This increases the level of thermal protection. The primary heat absorption is from a combination of phase change and endothermic reaction.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1-105. (canceled)

106. A method of forming a heat absorbing body comprising:
a) forming a porous body of a refractory material, the porous body comprising interstitial spaces;
b) forming a bath of a fluidic composition comprising a molten phase change material (PCM); and
c) positioning the porous body of the refractory material in contact with the bath of the fluidic composition, the fluidic composition being drawn into the interstitial spaces of the porous board of the refractory material via capillary action to form a PCM impregnated refractory body; and
d) cooling the PCM impregnated refractory body so that the molten PCM of the fluidic composition within the PCM impregnated refractory body solidifies.

107. The method of claim 106 wherein step c) comprises:
c-1) positioning the porous board of the refractory material in the bath of the fluidic composition so that an upper portion of the porous board of the refractory material is not submerged in the fluidic composition; and
c-2) the fluidic composition being drawn into the interstitial spaces of the upper portion of the porous board of the refractory material by said capillary action.

108. The method of claim 106 wherein step b) comprises melting a solid form of the PCM to form the molten PCM of the fluidic composition.

109. The method of claim 107 wherein the solid form of the PCM is a hydrated salt that is heated to a molten temperature between a first temperature at which the solid form of the hydrated salt melts and a second temperature at which water within the hydrated salt evaporates.

110. The method of claim 106 wherein step c) is performed for a time sufficient to saturate substantially all of said interstitial spaces with said fluidic composition.

111. The method of claim 106 wherein step a) comprises:
a-1) forming an aqueous slurry comprising refractory material fibers and a binder; and
a-2) dehydrating the aqueous slurry by applying a vacuum to the aqueous slurry, thereby forming the porous body of the refractory material.

112. The method of claim 111 wherein the refractory material fibers are alumina silica fibers and the binder is a combination of colloidal silica and an organic or inorganic binder.

113. The method of claim 106, wherein the porous body of a refractory material is a substantially rigid fibrous board comprising a fibrillary matrix.

114. The method of claim 106 wherein in step c) the porous body of the refractory material is positioned in the bath of the fluidic composition so that an upper portion of the porous body of the refractory material is not submerged in the fluidic composition.

115. The method of claim 106 wherein the porous body of the refractory material is contacted with the bath of the fluidic composition for from about 1 minute to about 5 minutes.

116. The method of claim 115 wherein the porous body of the refractory material is floated in the bath of the fluidic composition.

117. The method of claim 106 wherein step b) further comprises mixing a first reagent into the fluidic composition so that the fluidic composition comprises the molten PCM and the first reagent; and wherein step d) comprises cooling the PCM impregnated refractory body so that the molten PCM of the fluidic composition within the PCM impregnated refractory body solidifies, thereby entraining the first reagent in the solidified PCM.

118. A method of forming a heat absorbing body comprising:
a) forming a body comprising a fibrillary matrix of one or more refractory materials, wherein the fibrillary matrix has interstitial spaces;
b) contacting said body with a composition comprising a molten phase change material (PCM) for a time sufficient to saturate substantially all of said interstitial spaces with said composition; and
d) cooling said substantially saturated body for a time sufficient to solidify the molten PCM.

119. The method of claim 118 wherein step a) comprises:
a-1) preparing an aqueous slurry comprising at least one of said one or more refractory materials and a binder; and
a-2) applying a vacuum to the aqueous slurry for a time sufficient to remove substantially all of the water from said slurry.

120. The method of claim 118 wherein at least one of said one or more refractory materials is an alumina-silica fiber.

121. The method of claim 118 wherein in step b) the molten PCM comprises a hydrated salt selected from: sodium acetate tri-hydrate, calcium chloride hexahydrate, sodium sulfate decahydrate, and a combination of two or more thereof.

122. A method of forming a heat absorbing section for an enclosure comprising:
a) forming a porous body of a refractory material, the body comprising interstitial spaces;
b) contacting the porous body of the refractory material with a fluidic composition comprising a molten phase change material (PCM), the fluidic composition being drawn into the interstitial spaces of the porous body via capillary action to form a PCM impregnated refractory body;
c) cooling the PCM impregnated refractory body so that the molten PCM of the fluidic composition solidifies, thereby forming a first layer of the heat absorbing section; and
d) positioning a second reagent adjacent the first layer.

123. The method of claim 122 wherein the solidified PCM is a hydrated salt; and wherein the first reagent, when exposed to water released from the hydrated salt when the solidified PCM melts, endothermically reacts with the water.

124. The method of claim 123 wherein step d) comprises isolating the hydrated salt from the first reagent with a meltable barrier.

125. The method of claim 122 wherein the fluidic composition further comprises a first reagent, and wherein step c) comprises the first reagent being entrained in the solidified PCM; and wherein when the second reagent is exposed to the first reagent when the solidified PCM melts, the first and second reagents endothermically react.
